(19) United States
(12) Patent Application Publication
(10) Pub. No.: US 2008/0088933 A1
(43) Pub. Date: Apr. 17, 2008

(54) Optical film for overcoming optical defects

(76) Inventor: Ching-Bin Lin, Taipei (TW)

Correspondence Address: Ching-Bin Lin, P. O. Box 55-846, Taipei, 104, omitted

(21) Appl. No.: 11/581,036

(22) Filed: Oct. 16, 2006

(51) Int. Cl. G02B 5/02

(52) U.S. Cl. 359/599; 359/707

(57) ABSTRACT

An optical film includes a transparent supporting (or base) layer; a structured layer integrally formed on the supporting layer and having a plurality of light-concentrating units including prism units juxtapositionally formed on the supporting layer; and a plurality of tiny protrusions or recesses formed on (or in) the surfaces of the light-concentrating units to overcome the optical defects of the optical film and to synergetically enhance the optical properties of the optical film.

### BACKGROUND OF THE INVENTION

In order to increase the light amount directed normal to the axis of the optical display for increasing the brightness, it is usually to place two sheets of optical films adjacent one another with the prisms of the two films oriented approximately perpendicular with one another. Unfortunately, the two films very near contacted may cause optical coupling or wet-out.

U.S. Pat. No. 5,771,328 (prior art) disclosed an optical film having taller prisms (56) taller than the shorter prisms (54) to be first contacted with another sheet of optical film to limit the physical proximity of another sheet of optical film, thereby reducing the visible wet-out condition (FIG. 4 of the prior art). However, such taller prisms may still appear as visible lines on the surface of a film.

Conventional method for reducing moiré fringe is to physically separate the moiré pattern producing structures of the adjacent optical films. However, this may increase the thickness and complexity of the display assembly and may therefore be unacceptable commercially.

Still, most optical films formed with prisms or prism arrays thereon may have light concentrating effect to increase the on-axis brightness of the optical films or devices. However, it may cause light ununiformity of the optical films accordingly.

The present inventor has found the optical defects caused by the conventional arts as above-mentioned and invented the present optical film for overcoming the optical defects.

### SUMMARY OF THE INVENTION

The object of the present invention is to provide an optical film including a transparent supporting (or base) layer; a structured layer integrally formed on the supporting layer and having a plurality of light-concentrating units including prism units juxtapositionally formed on the supporting layer; and a plurality of tiny protrusions or recesses formed on (or in) the surfaces of the light-concentrating units to overcome the optical defects of the optical film and to synergetically enhance the optical properties of the optical film.

### BRIEF DESCRIPTION OF THE DRAWINGS

FIG. 1 shows a first preferred embodiment of the present invention.

FIG. 2 shows a second preferred embodiment of the present invention.

FIG. 3 shows a third preferred embodiment of the present invention.

FIG. 4 shows a fourth preferred embodiment of the present invention.

FIG. 5 shows a fifth preferred embodiment of the present invention.

FIG. 6 shows a sixth preferred embodiment of the present invention.

FIG. 7 shows a seventh preferred embodiment of the present invention.

FIG. 8 shows an eighth preferred embodiment of the present invention.

FIG. 9 shows a ninth preferred embodiment of the present invention.

FIG. 10 shows a tenth preferred embodiment of the present invention.

### DETAILED DESCRIPTION

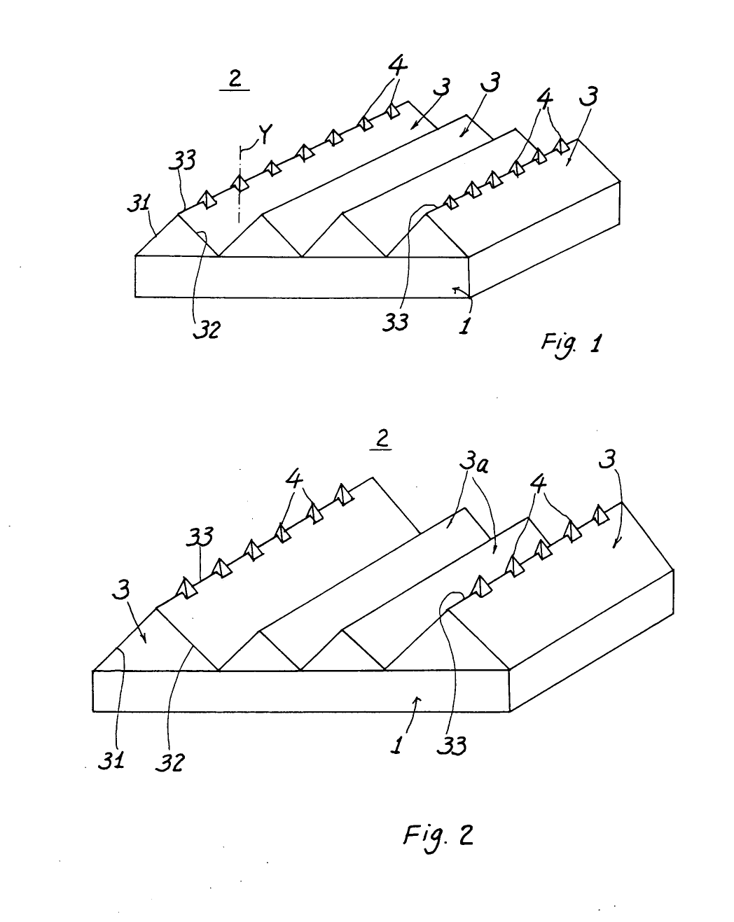

As shown in FIG. 1, the optical film of the present invention comprises: a transparent supporting (or base) layer 1; a structured layer 2 including a plurality of light-concentrating units 3 (such as prism units 3) juxtapositionally formed on the supporting layer 1; and a plurality of tiny protrusions 4 integrally formed on the peak lines 33 of the light-concentrating units 3.

The transparent supporting layer 1 may be made of thermoplastic resin, including: polyethylene terephthalate (PET) and polycarbonate (PC).

The structured layer 2 is formed by a plurality of light-concentrating units 3, including prism units 3.

Each light-concentrating unit 3, formed as a prism (or prism array) unit 3 as shown in FIG. 1, includes two prism faces 31, 32 tapered upwardly from a prism base to be intersected at a peak line 33 formed on a peak of each prism unit 3.

The tiny protrusions 4 are intermittently formed on the peak line 33 of the prism unit 3; with every two neighboring protrusions 4, 4 separated at a small distance therebetween.

Partial prism units 3 are formed with the tiny protrusions 4 thereon as shown in FIG. 1. For example, two rows of prism units 3 are not formed with the protrusions 4 thereon, and are defined in between the other two rows of taller prim units 3 having tiny protrusions 4 formed thereon as shown in FIG. 1.

So, the prism unit 3 having tiny protrusions 4 formed thereon will be taller than the prism unit 3 not formed with protrusions 4 thereon.

When stacking another sheet of optical film on the taller prism unit 3 of the present invention, the taller prism unit 3 as effected by the tiny protrusion 4 formed on the peak line 33 of the prism unit 3 will first contact another sheet of optical film to limit the physical proximity of another sheet of optical film, thereby eliminating the optical coupling (wt-out) and moiré fringe.

The “line image” of each peak line 33 of the prior art is now “reduced”, shortened or minimized to be a “point image” of each tiny protrusion 4 formed on the peak line 33, thereby being more acceptable commercially.

Each tiny protrusion 4 may be formed as a polyhedral pyramid, a cone, a dome, an arcuate shape, a small prism or a small convex lens tapered upwardly about a vertical axis Y of each protrusion 4 for directing light upwardly within a narrowed output angle for enhancing its light-concentrating effect, thereby increasing the brightness of the optical film.

The prism units 3 and the tiny protrusions 4 are integrally formed on the supporting layer I by integral molding process, imprinting process or other processes.

The structured layer 2 including the prism units 3 and the tiny protrusions 4 may be made of photo-sensitive or photo-curing resin, or thermosetting resin, including UV curable resin.

Although the related design data or parameters are not limited in the present invention, the following data are preferable for the corresponding elements:
The distance between every two tiny protrusions (4) - - - 25˜300 μm;
The height of each tiny protrusion - - - 0.5˜2.0 μm;
The pitch between two peak lines (33) having protrusions (4) formed thereon - - - <300 μm.

Naturally, the size, dimension, pitches, shapes, distribution or lay-out, regularity or irregularity, of the related elements or structured portions of the present invention are not limited.

As shown in FIG. 2, two rows of prism units 3a are each lower than the height of the taller prism unit 3 having the tiny protrusions 4 formed on the taller prism unit 3.

This is a modification as made from that as shown in FIG. 1 in accordance with the present invention.

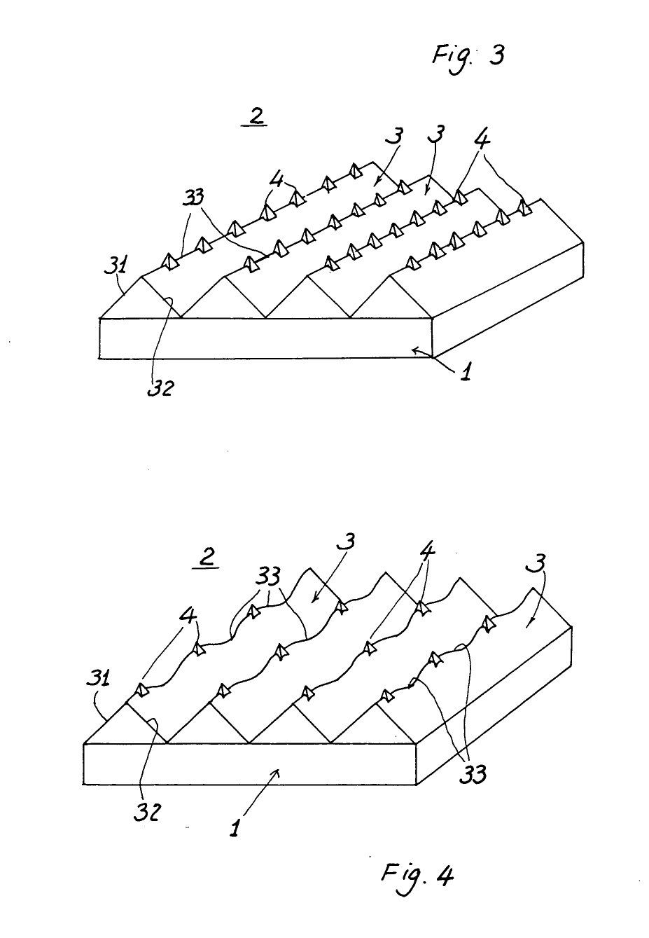

As shown in FIG. 3, each prism unit 3 has its peak line 33 formed with a plurality of tiny protrusions 4 on each peak line 33, forming another modification of the present invention.

As shown in FIG. 4, each peak line 33 of the prism unit 3 includes variable heights along the length of the peak line 33, and a plurality of tiny protrusions 4 are formed on each peak line 33 of each prism unit 3, thereby forming still another modification of the present invention.

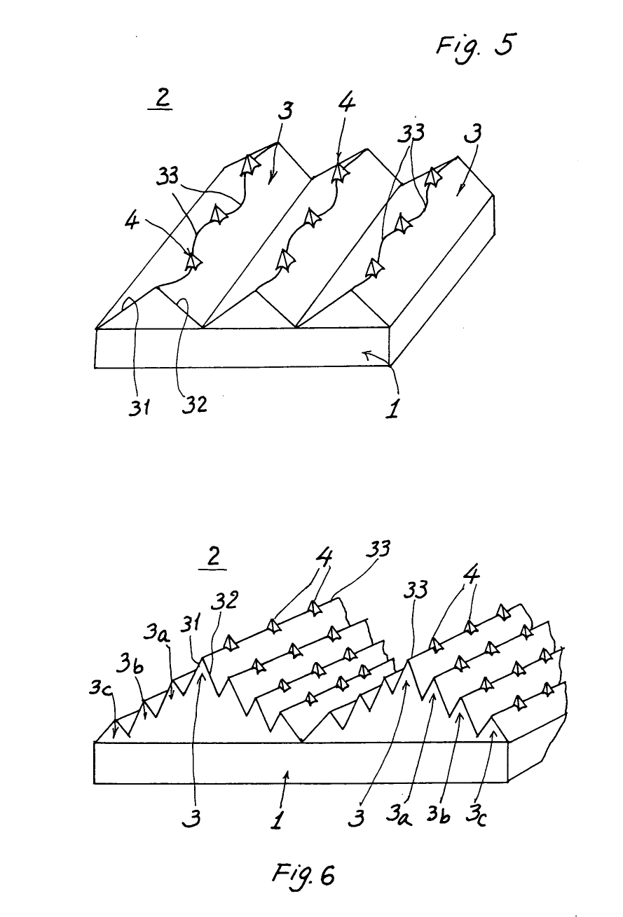

The peak line 33 as shown in FIG. 5 has been modified to be wavy or corrugated line as viewed from a top view thereof, having the plurality of tiny protrusions 4 formed on the peak line 33.

As shown in FIG. 6, the structured layer 2 includes a plurality of prism units 3, 3a, 3b and 3c having different or variable heights of the prism units 3 integrally formed on the base layer 1. The plurality of tiny protrusions 4 are formed on each peak line 33 formed on each prism unit 3, 3a, 3b and 3c.

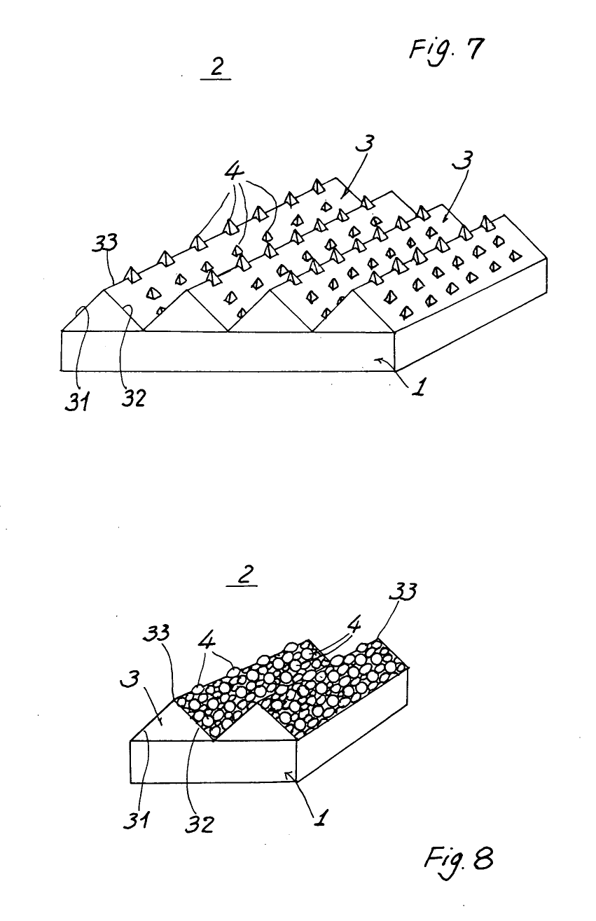

As shown in FIG. 7, each prism unit 3 has its peak line 33 and the prism faces 31, 32 respectively formed with a plurality of tiny protrusions 4 on the peak line 33 and the prism faces 31, 32. In this preferred embodiment, the protrusions 4 formed on the peak line 33 will limit the physical proximity of another stackable sheet of optical film to thereby prevent the wet-out condition; while the protrusions 4 formed on the dihedral prism faces 31, 32 will serve as many many light-directing tiny elements for further refracting light ray (as entering the protrusions 4) from each prism unit 3 for increasing the light-diffusing effect of the optical film, thereby overcoming the light ununiformity of the optical film having prismatic structured layer formed on base layer.

Accordingly, this invention will overcome the optical defects including optical coupling and moiré fringe; and will also synergetically increase the light-diffusing effect in addition to its light-concentrating effect.

So, passively this invention will overcome the optical defects of an optical film; and actively this invention will enhance the optical properties of the optical film.

As shown in FIG. 8, the tiny protrusions 4 formed on the surfaces of the prism units 3 are each modified to be an arcuate or tiny dome shape protruding upwardly or outwardly from the prism surfaces.

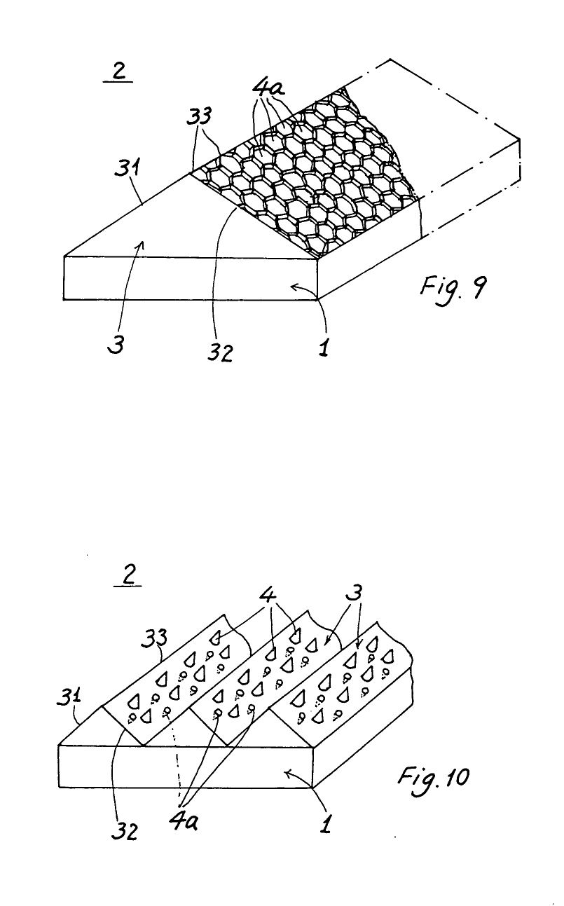

As shown in FIG. 9, the tiny protrusions 4 have been modified to be tiny recesses 4a as recessed in the surfaces of the prism units 3.

Even though the recess 4a as shown in FIG. 9 is formed as a hexagonal recess. However, the shapes of the recesses 4a are also not limited in the present invention.

As shown in FIG. 10, the prism units 3 have their surfaces formed with tiny protrusions 4 thereon and recesses 4a therein. It indicates that the protrusions 4 and recesses 4a are mixedly formed on (or in) the prism unit 3 to form a diffusing surface layer on the prism unit 3 for increasing the light uniformity; or, in other words, for overcoming the light ununiformity defect.

The protrusions 4 and recesses 4a may be continuously or intermittently formed on (or in) the faces or peak lines of the light-concentrating units or prism unit 3 of the present invention.

Each protrusion 4 may also be defined as a convex lens; while each recess 4a be defined as a concave lens.

Conclusively, the protrusion 4 or recess 4a as aforementioned may be comprehensively defined a “light-directing element” or “light-directing tiny element” in the present invention.

The present invention may be modified without departing from the spirit and scope of the present invention.

The protrusions 4 or recesses 4a may be selectively, partially or fully formed on (or in) the portion of the light-concentrating units or prism units 3 of the present invention.

I claim:

1. An optical film comprising:
a transparent supporting layer;
a structured layer including a plurality of light-concentrating units integrally formed on said supporting layer; and
a plurality of light-directing tiny elements integrally formed on at least a portion or a surface of one said light-concentrating unit.

2. An optical film according to claim 1, wherein said light-directing tiny element is a tiny protrusion selectively formed on a top portion or a surface portion of each said light-concentrating unit.

3. An optical film according to claim 1, wherein said light-directing tiny element is a tiny recess recessed in a portion of said light-concentrating unit.

4. An optical film according to claim 1, wherein each said light-concentrating unit is a prism unit; one said prism unit having a height being same with or different from that of another neighboring prism unit.

5. An optical film according to claim 1, wherein each said light-directing tiny element is formed as a shape selected from the group consisting of: a pyramid, a cone, a dome, a lens, a prism, an arcuate shape, and a polyhedral shape.

6. An optical film according to claim 1, wherein said light-directing tiny elements are intermittently formed on said light-concentrating units; whereby one said light-concentrating unit has said light-directing tiny elements formed on a top portion of said light-concentrating unit, it will be higher than the other light-concentrating unit without being formed with said light-directing tiny elements thereon to prevent wet-out condition.

7. An optical film according to claim 1, wherein said light-directing tiny element is a convex lens.

8. An optical film according to claim 1, wherein said light-directing tiny element is a concave lens.

9. An optical film according to claim 4, wherein said prism unit includes a plurality of tiny protrusions formed on a peak line as intersected by two prism faces of said prism unit as tapered upwardly.

10. An optical film according to claim 9, wherein said peak line is varied with its height along a length of said peak line of said prism unit.

11. An optical film according to claim 9, wherein said peak line is formed as a wavy line when viewed from a top view on said prism unit, having said tiny protrusions formed on said peak line.

12. An optical film comprising:
a transparent supporting layer;
a structured layer having a plurality of light-concentrating units including prism units integrally formed on said supporting layer; and
a plurality of tiny protrusions integrally formed on at least a portion of one said light-concentrating unit.

13. An optical film comprising:
a transparent supporting layer;
a structured layer having a plurality of light-concentrating units including prism units integrally formed on said supporting layer; and
a plurality of tiny recesses recessed in at least a surface portion of one said light-concentrating unit.

14. An optical film according to claim 12, wherein said light-concentrating unit further includes a plurality of recesses recessed in a surface portion of said light-concentrating unit to form a light-concentrating unit having said tiny protrusions and said tiny recesses integrally formed on or in said light-concentrating unit.

15. An optical film according to claim 12, wherein said tiny protrusions are integrally formed on a peak line formed on a top of one said prism unit, with every two neighboring tiny protrusions separated in a distance.

16. An optical film according to claim 1, wherein said structured layer and said light-directing tiny elements are integrally formed on said supporting layer by integral molding process or by imprinting process.
